(19) United States
(12) Patent Application Publication
(10) Pub. No.: US 2015/0334704 A1
(43) Pub. Date: Nov. 19, 2015

(54) INTRA-CLUSTER COORDINATION FOR CELL CLUSTERING INTERFERENCE MITIGATION

(71) Applicants: Chao WEI, Chaoyang District, Beijing (CN); Jiming GUO, (US); Jilei HOU, (US); QUALCOMM INCORPORATED, San Diego, CA (US)

(72) Inventors: Chao Wei, Beijing (CN); Jiming Guo, Beijing (CN); Jilei Hou, Beijing (CN)

(21) Appl. No.: 14/650,669

(22) PCT Filed: Jan. 9, 2014
(86) PCT No.: PCT/CN2014/000027

§ 371 Date: Jun. 9, 2015

(30) Foreign Application Priority Data
Jan. 17, 2013 (CN) PCT/CN2013/000049

(51) Int. Cl. H04W 72/04; H04W 24/02; H04L 5/14

(52) U.S. Cl. CPC H04W 72/0446; H04L 5/14; H04W 24/02

(57) ABSTRACT

Dynamic intra-cluster coordination for TDD UL-DL reconfiguration using distributed TDD UL-DL reconfiguration techniques and/or new physical layer signaling. Cell weighting techniques may be used so that distributed TDD UL-DL reconfiguration of the cell cluster can be weighted towards cells of the cluster with higher load. Cells within a cell cluster may independently determine their preferred TDD UL-DL reconfiguration and one or more cells of the cluster may be eligible cells for determining the TDD UL-DL reconfiguration for the cluster. Special subframes may be used for transmission of TDD UL-DL reconfiguration messages from the configuring cell and transmission of ACK messages from other cells of the cluster. The TDD UL-DL reconfiguration message may be an orthogonal sequence based on a signature determined by the cell ID of the configuring cell.

### CROSS REFERENCES

The present Application for Patent claims priority to International Patent Application No. PCT/CN2013/000049 to Qualcomm Incorporated et al., entitled “Intra-Cluster Coordination for Cell Clustering Interference Mitigation,” filed Jan. 17, 2013, assigned to the assignee hereof, and expressly incorporated by reference herein.

### BACKGROUND

Wireless communication networks are widely deployed to provide various communication services such as voice, video, packet data, messaging, broadcast, and the like. These wireless networks may be multiple-access networks capable of supporting multiple users by sharing the available network resources.

A wireless communication network may include a number of base stations or Node-Bs that can support communication for a number of user equipments (UEs). A UE may communicate with a base station via downlink (DL) and uplink (UL) transmissions. The downlink (or forward link) refers to the communication link from the base station to the UE, and the uplink (or reverse link) refers to the communication link from the UE to the base station.

Multiple access technologies may use Frequency Division Duplexing (FDD) or Time Division Duplexing (TDD) to provide uplink and downlink communications over one or more carriers. TDD operation offers flexible deployments without requiring paired spectrum resources. Cell clustering and synchronization of uplink and downlink resources between base stations may be used to assist in interference mitigation, but may pose challenges for meeting rapidly changing load conditions.

### SUMMARY

Described embodiments support dynamic intra-cluster coordination for TDD UL-DL reconfiguration. In embodiments, distributed TDD UL-DL reconfiguration techniques provide fully distributed, fair, and collision-free intra-cluster coordination of TDD UL-DL reconfiguration with adaptive reconfiguration on the order of a single frame period. In some embodiments, new physical layer signaling and/or techniques are defined for supporting dynamic intra-cluster coordination using distributed TDD UL-DL reconfiguration. Cell weighting techniques may be used so that distributed TDD UL-DL reconfiguration of the cell cluster can be weighted towards cells of the cluster with higher load (e.g., DL and/or UL load).

In some embodiments, cells within a cell cluster independently determine their preferred TDD UL-DL reconfiguration. One or more cells of the cluster may be eligible cells to determine the TDD UL-DL configuration for the cluster for a frame. Each of the eligible cells may determine the configuring cell. Determination of the configuring cell may be based on a pseudo-random function of the frame number and cell identifiers of the set of eligible cells. In some embodiments, the configuring cell may send the TDD UL-DL reconfiguration over backhaul interfaces to the other cells of the cluster.

In some embodiments, the configuring cell may transmit the TDD UL-DL reconfiguration using over-the-air (OTA) physical layer signaling during a transmission opportunity associated with the frame. Other cells of the cluster may acknowledge the transmitted TDD UL-DL reconfiguration. In some embodiments, special subframes of the current TDD frame sequence that serve as a switching point between DL and UL transmissions are used for transmission of TDD UL-DL reconfiguration messages from the configuring cell and transmission of ACK messages from other cells of the cluster. The TDD UL-DL reconfiguration messages may be sent in a guard period of the special subframe. The TDD UL-DL reconfiguration message may be an orthogonal sequence based on a signature determined by its cell ID. A cyclic shift of the orthogonal sequence may be associated with a predetermined TDD UL-DL configuration. ACK messages may also be orthogonal sequences and may include the predetermined TDD UL-DL configuration.

Embodiments are directed to a method for coordinating TDD UL-DL configuration for a cell cluster of a wireless communications network. The method may include determining, at a cell in the cell cluster, a configuring cell from a set of eligible cells for UL-DL configuration for the subsequent TDD frame, the set of eligible cells including the cell and at least one other cell in the cell cluster, selecting, if the cell is the configuring cell, a first TDD UL-DL configuration for the subsequent TDD frame, and sending, if the cell is the configuring cell, the first TDD UL-DL configuration for the subsequent TDD frame to cells of the cell cluster.

Embodiments are directed to an apparatus for coordinating TDD UL-DL configuration for a cell cluster of a wireless communications network. The apparatus may include means for determining, at a cell of the cell cluster, a configuring cell from a set of eligible cells for a transmission opportunity associated with UL-DL configuration for the subsequent TDD frame, the set of eligible cells including the cell and at least one other cell in the cell cluster, means for selecting a first TDD UL-DL configuration for a subsequent TDD frame, and means for sending, if the cell is the configuring cell, the first TDD UL-DL configuration for the subsequent TDD frame to cells of the cell cluster.

Embodiments are directed to a communications device for coordinating TDD UL-DL configuration for a cell cluster of a wireless communications network including at least one processor configured to determine, at a cell in the cell cluster, a configuring cell from a set of eligible cells for UL-DL configuration for the subsequent TDD frame, the set of eligible cells including the cell and at least one other cell in the cell cluster, select, if the cell is the configuring cell, a first TDD UL-DL configuration for the subsequent TDD frame, and send, if the cell is the configuring cell, the first TDD UL-DL configuration for the subsequent TDD frame to cells of the cell cluster.

Embodiments are directed to a computer program product for coordinating TDD UL-DL configuration for a cell cluster of a wireless communications network. The computer program product may include a non-transitory computer-readable medium including code for causing a computer to determine, at a cell in the cell cluster, a configuring cell from a set of eligible cells for UL-DL configuration for the subsequent TDD frame, the set of eligible cells including the cell and at least one other cell in the cell cluster, select, if the cell is the configuring cell, a first TDD UL-DL configuration for the subsequent TDD frame, and send, if the cell is the configuring cell, the first TDD UL-DL configuration for the subsequent TDD frame to cells of the cell cluster.

In certain examples of the methods, apparatuses, devices, or computer program products the configuring cell may be determined based on at least one of a pseudo-random, relative load, available capacity, fairness, priority, or tokenized function based at least in part on cell identifiers of the set of eligible cells.

In certain examples of the methods, apparatuses, devices, or computer program products, communication of TDD UL-DL reconfiguration may be performed over backhaul interfaces between the cells. For example, sending the first TDD UL-DL configuration may include sending a message comprising the first TDD UL-DL configuration to the cells of the cell cluster over a backhaul interface.

In certain examples of the methods, apparatuses, devices, or computer program products, communication of TDD UL-DL reconfiguration may be performed using OTA physical layer signaling. For example, sending the first TDD UL-DL configuration may include transmitting an indicator of the first TDD UL-DL configuration in a transmission opportunity of a TDD frame preceding the subsequent TDD frame. The transmission opportunity may be a gap period between downlink and uplink subframes of the preceding TDD frame.

In certain examples of the methods, apparatuses, devices, or computer program products, reconfiguration sent during one frame becomes effective the next frame. For example, the transmission opportunity for TDD UL-DL reconfiguration may be within a TDD frame immediately preceding the subsequent TDD frame where reconfiguration becomes effective. In some embodiments, reconfiguration sent during one frame becomes effective after a predetermined number (e.g., 2, 3, etc.) of frames. For example, the transmission opportunity for TDD UL-DL reconfiguration for frame N+2 may be within frame N.

In certain examples of the methods, apparatuses, devices, or computer program products, transmission of the TDD UL-DL reconfiguration includes transmitting an orthogonal sequence based on a cell identifier of the cell. A cyclic shift of the orthogonal sequence may be associated with one TDD UL-DL configuration of a set of predefined TDD UL-DL configurations for the wireless communications network.

In some embodiments, the method includes receiving, if the cell is not the configuring cell, a TDD UL-DL configuration for the subsequent TDD frame from the configuring cell and utilizing the TDD UL-DL configuration for the subsequent TDD frame. The method may include transmitting an acknowledgement of the received TDD UL-DL configuration. The TDD UL-DL configuration may be received within a gap period between downlink and uplink subframes of a TDD frame and the acknowledgement may be transmitted within a subsequent gap period within the TDD frame. The acknowledgement may include the received TDD UL-DL configuration. The described apparatuses, devices, and/or computer program products may include means for, code for, or instructions executable by a processor to perform these features.

In some embodiments, the method includes determining the set of eligible cells based at least in part on eligible intervals and holdoff periods for cells of the cell cluster. The method may include determining that the cell is in the set of eligible cells for a predetermined number of additional TDD frames of an eligible interval based at least in part on determining that the cell is the configuring cell for a TDD frame preceding the additional TDD frames. All cells of the cluster may use the same holdoff period while eligible intervals may vary by cell and may be based at least in part on loading metrics of the cells. The described apparatuses, devices, and/or computer program products may include means for, code for, or instructions executable by a processor to perform these features.

Embodiments are directed to a method for communicating TDD UL-DL configurations between cells of a cell cluster of a wireless communications network. The method may include generating, at a cell of the cell cluster, an orthogonal sequence encoded with a cell identifier of the cell and an UL-DL configuration for a subsequent frame of a TDD carrier and transmitting, to at least one cell of the cell cluster, the orthogonal sequence during a first special subframe of a first frame of the TDD carrier.

Embodiments are directed to an apparatus for communicating TDD UL-DL configurations between cells of a cell cluster of a wireless communications network. The apparatus may include means for generating, at a cell of the cell cluster, an orthogonal sequence encoded with a cell identifier of the cell and an UL-DL configuration for a subsequent frame of a TDD carrier, and means for transmitting, to at least one cell of the cell cluster, the orthogonal sequence during a first special subframe of a first frame of the TDD carrier.

Embodiments are directed to a communications device for communicating TDD UL-DL configurations between cells of a cell cluster of a wireless communications network including at least one processor configured to generate, at a cell of the cell cluster, an orthogonal sequence encoded with a cell identifier of the cell and an UL-DL configuration for a subsequent frame of a TDD carrier, and transmit, to at least one cell of the cell cluster, the orthogonal sequence during a first special subframe of a first frame of the TDD carrier.

Embodiments are directed to a computer program product for communicating TDD UL-DL configurations between cells of a cell cluster of a wireless communications network. The computer program product may include a non-transitory computer-readable medium including code for causing a computer to generate, at a cell of the cell cluster, an orthogonal sequence encoded with a cell identifier of the cell and an UL-DL configuration for a subsequent frame of a TDD carrier, and code for causing the computer to transmit, to at least one cell of the cell cluster, the orthogonal sequence during a first special subframe of a first frame of the TDD carrier.

In some embodiments, the method includes receiving, from the at least one cell, an acknowledgement of reception of the orthogonal sequence by the at least one cell. The acknowledgement may be received during a second special subframe of the first frame or during a second special subframe of a second frame subsequent to the first frame. The received acknowledgement may include an orthogonal acknowledgement sequence, where the orthogonal acknowledgement sequence is encoded with the UL-DL configuration. The orthogonal sequence may be transmitted within a gap period between downlink and uplink transmission portions of the first special subframe. A cyclic shift of the orthogonal sequence may be associated with the UL-DL configuration. The described apparatuses, devices, and/or computer program products may include means for, code for, or instructions executable by a processor to perform these features.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a diagram illustrating an example of a wireless communications system in accordance with various embodiments;

FIG. 2 illustrates a Cell Clustering Interference Mitigation environment with cells grouped according to cell clusters in accordance with various embodiments;

FIG. 3 illustrates a method for intra-cluster coordination of TDD UL-DL configuration in accordance with various embodiments;

FIGS. 4A and 4B are timing diagrams illustrating TDD UL-DL reconfiguration using physical layer signaling during special subframes in accordance with various embodiments;

FIG. 5 illustrates an orthogonal sequence 500 for transmitting TDD UL-DL configurations in accordance with various embodiments;

FIG. 6A is a timing diagram illustrating timing of orthogonal sequences transmitted for dynamic TDD UL-DL reconfiguration in a TDD frame having a half-period TDD switching period in accordance with various embodiments;

FIG. 6B is a timing diagram illustrating timing of orthogonal sequences transmitted for dynamic TDD UL-DL reconfiguration in a TDD frame where the TDD switching period is equal to the radio frame period in accordance with various embodiments;

FIG. 6C is a timing diagram 600-b illustrating alternative timing of preamble sequences transmitted for dynamic TDD UL-DL reconfiguration in a TDD frame where the TDD switching period is equal to the radio frame period in accordance with various embodiments;

FIG. 7 illustrates a method for weighted dynamic distributed TDD UL-DL reconfiguration in accordance with various embodiments;

FIG. 8 is a timing diagram that illustrates an example sequence of weighted dynamic distributed TDD UL-DL reconfiguration in accordance with various embodiments;

FIGS. 9A and 9B illustrate devices for supporting dynamic distributed TDD UL-DL reconfiguration within cell clusters in accordance with various embodiments;

FIG. 10 illustrates a device 1000 for communicating TDD UL-DL reconfiguration within cell clusters in accordance with various embodiments; and

FIG. 11 shows a block diagram of a communications system that may be configured for supporting dynamic distributed TDD UL-DL reconfiguration within cell clusters in accordance with various embodiments.

### DETAILED DESCRIPTION

Described embodiments are directed to systems and methods for supporting dynamic intra-cluster coordination for TDD UL-DL reconfiguration. In embodiments, distributed TDD UL-DL reconfiguration techniques provide fully distributed, fair, and collision-free intra-cluster coordination of TDD UL-DL reconfiguration with adaptive reconfiguration on the order of a single frame period. In some embodiments, new physical layer signaling and/or techniques are defined for supporting dynamic intra-cluster coordination using distributed TDD UL-DL reconfiguration. Cell weighting techniques may be used so that distributed TDD UL-DL reconfiguration of the cell cluster can be weighted towards cells of the cluster with higher load (e.g., DL and/or UL load).

In some embodiments, cells within a cell cluster independently determine their preferred TDD UL-DL reconfiguration. One or more cells of the cluster may be eligible cells for a transmission opportunity to determine the TDD UL-DL reconfiguration for the cluster. Each of the eligible cells may determine the configuring cell. Determination of the configuring cell may be based on a pseudo-random function of cell identifiers of the set of eligible cells. In some embodiments, the configuring cell may send the TDD UL-DL reconfiguration over backhaul interfaces to the other cells of the cluster.

In some embodiments, the configuring cell may transmit the TDD UL-DL reconfiguration using over-the-air (OTA) physical layer signaling during the transmission opportunity. Other cells of the cluster may transmit OTA acknowledgements of the transmitted TDD UL-DL reconfiguration. In some embodiments, special subframes of the current TDD frame sequence that serve as a switching point between DL and UL transmissions are used for transmission of TDD UL-DL reconfiguration messages from the configuring cell and transmission of ACK messages from other cells of the cluster. The TDD UL-DL reconfiguration messages may be sent in a guard period of the special subframe. The TDD UL-DL reconfiguration message may be an orthogonal sequence based on a signature determined by its cell ID. A cyclic shift of the orthogonal sequence may be associated with a predetermined TDD UL-DL configuration. ACK messages may also be orthogonal sequences and may include the predetermined TDD UL-DL configuration.

Techniques described herein may be used for various wireless communications systems such as cellular wireless systems, Peer-to-Peer wireless communications, wireless local access networks (WLANs), ad hoc networks, satellite communications systems, and other systems. The terms “system” and “network” are often used interchangeably. These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. Examples of TDMA systems include various implementations of

Global System for Mobile Communications (GSM). Examples of Radio Access Technologies employing OFDM and/or OFDMA include Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

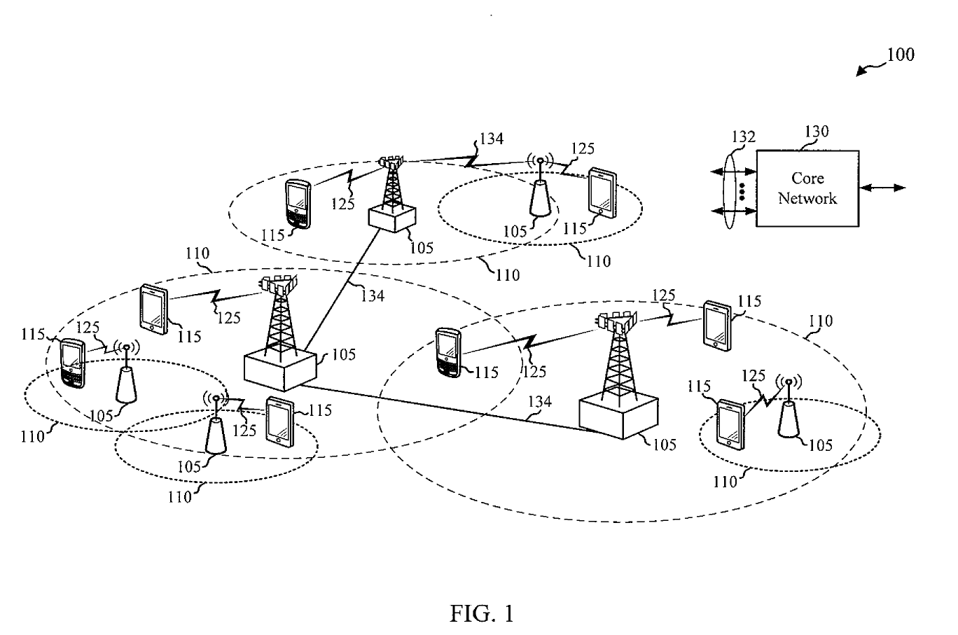

Referring first to FIG. 1, a diagram illustrates an example of a wireless communications system 100. The system 100 includes base stations (or cells) 105, communication devices 115, and a core network 130. The base stations 105 may communicate with the communication devices 115 under the control of a base station controller (not shown), which may be part of the core network 130 or the base stations 105 in various embodiments. Base stations 105 may communicate control information and/or user data with the core network 130 through backhaul links 132. Backhaul links may be wired backhaul links (e.g., copper, fiber, etc.) and/or wireless backhaul links (e.g., microwave, etc.). In embodiments, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the devices 115 via one or more base station antennas. Each of the base station 105 sites may provide communication coverage for a respective geographic area 110. In some embodiments, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, and/or pico base stations). There may be overlapping coverage areas for different technologies.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. In embodiments, some eNBs 105 may be synchronous while other eNBs may be asynchronous.

The communication devices 115 are dispersed throughout the wireless network 100, and each device may be stationary or mobile. A communication device 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a user equipment, a mobile client, a client, or some other suitable terminology. A communication device 115 may be a cellular phone, a personal digital assistant (PDA), a wireless modem, a wireless communication device, a handheld device, a tablet computer, a laptop computer, a cordless phone, a wireless local loop (WLL) station, or the like. A communication device may be able to communicate with macro base stations, pico base stations, femto base stations, relay base stations, and the like.

The transmission links 125 shown in network 100 may include uplink (UL) transmissions from a mobile device 115 to a base station 105, and/or downlink (DL) transmissions, from a base station 105 to a mobile device 115. The downlink transmissions may also be called forward link transmissions while the uplink transmissions may also be called reverse link transmissions. In embodiments, the transmission links 125 are TDD carriers carrying bidirectional traffic within traffic frames.

In embodiments, the system 100 is an LTE/LTE-A network. In LTE/LTE-A networks, the terms evolved Node B (eNB) and user equipment (UE) may be generally used to describe the base stations 105 and communication devices 115, respectively. The system 100 may be a Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The communications system 100 according to an LTE/LTE-A network architecture may be referred to as an Evolved Packet System (EPS) 100. The EPS 100 may include one or more UEs 115, an Evolved UMTS Terrestrial Radio Access Network (E-UTRAN), an Evolved Packet Core (EPC) 130 (e.g., core network 130), a Home Subscriber Server (HSS), and an Operator's IP Services. The EPS may interconnect with other access networks using other Radio Access Technologies. For example, EPS 100 may interconnect with a UTRAN-based network and/or a CDMA-based network via one or more Serving GPRS Support Nodes (SGSNs). To support mobility of UEs 115 and/or load balancing, EPS 100 may support handover of UEs 115 between a source eNB 105 and a target eNB 105. EPS 100 may support intra-RAT handover between eNBs 105 and/or base stations of the same RAT (e.g., other E-UTRAN networks), and inter-RAT handovers between eNBs and/or base stations of different RATs (e.g., E-UTRAN to CDMA, etc.). The EPS 100 may provide packet-switched services, however, as those skilled in the art will readily appreciate, the various concepts presented throughout this disclosure may be extended to networks providing circuit-switched services.

The E-UTRAN may include the eNBs 105 and may provide user plane and control plane protocol terminations toward the UEs 115. The eNBs 105 may be connected to other eNBs 105 via backhaul link 134 (e.g., an X2 interface, and the like). The eNBs 105 may provide an access point to the EPC 130 for the UEs 115. The eNBs 105 may be connected by backhaul link 132 (e.g., an S1 interface, and the like) to the EPC 130. Logical nodes within EPC 130 may include one or more Mobility Management Entities (MMEs), one or more Serving Gateways, and one or more Packet Data Network (PDN) Gateways (not shown). Generally, the MME may provide bearer and connection management. All user IP packets may be transferred through the Serving Gateway, which itself may be connected to the PDN Gateway. The PDN Gateway may provide UE IP address allocation as well as other functions. The PDN Gateway may be connected to IP networks and/or the operator's IP Services. These logical nodes may be implemented in separate physical nodes or one or more may be combined in a single physical node. The IP Networks/Operator's IP Services may include the Internet, an Intranet, an IP Multimedia Subsystem (IMS), and/or a Packet-Switched (PS) Streaming Service (PSS).

The UEs 115 may be configured to collaboratively communicate with multiple eNBs 105 through, for example, Multiple Input Multiple Output (MIMO), Coordinated Multi-Point (CoMP), or other schemes. MIMO techniques use multiple antennas on the base stations and/or multiple antennas on the UE to take advantage of multipath environments to transmit multiple data streams. Each data stream may be called a “layer” and the “rank” of the communication link may indicate the number of layers used for communication. CoMP includes techniques for dynamic coordination of transmission and reception by a number of eNBs to improve overall transmission quality for UEs as well as increasing network and spectrum utilization. Generally, CoMP techniques utilize backhaul links 132 and/or 134 for communication between base stations 105 to coordinate control plane and user plane communications for the UEs 115.

The communication networks that may accommodate some of the various disclosed embodiments may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. In the control plane, the Radio Resource Control (RRC) protocol layer may provide establishment, configuration, and maintenance of an RRC connection between the UE and the network used for the user plane data. At the Physical layer, the transport channels may be mapped to Physical channels.

LTE/LTE-A utilizes orthogonal frequency division multiple-access (OFDMA) on the downlink and single-carrier frequency division multiple-access (SC-FDMA) on the uplink. An OFDMA and/or SC-FDMA carrier may be partitioned into multiple (K) orthogonal subcarriers, which are also commonly referred to as tones, bins, or the like. Each subcarrier may be modulated with data. The spacing between adjacent subcarriers may be fixed, and the total number of subcarriers (K) may be dependent on the system bandwidth. For example, K may be equal to 72, 180, 300, 600, 900, or 1200 with a subcarrier spacing of 15 kilohertz (KHz) for a corresponding system bandwidth (with guardband) of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands.

The carriers may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined. Time intervals may be expressed in multiples of a basic time unit Tₛ=1/30720000. Each frame structure may have a radio frame length T_{f}=307200·Tₛ=10 ms and may include two half-frames of length 153600·Tₛ=5 ms each. Each half-frame may include five subframes of length 30720·Tₛ=1 ms.

For TDD frame structures, each subframe may carry UL or DL traffic, and special subframes (“S”) may be used to switch between DL to UL transmission. Allocation of UL and DL subframes within radio frames may be symmetric or asymmetric and may be reconfigured semi-statically (e.g., via backhaul messaging over S1 and/or X2 interfaces, etc.). Special subframes may carry some DL and/or UL traffic and may include a Guard Period (GP) between DL and UL traffic. Switching from UL to DL traffic may be achieved by setting timing advance at the UEs without the use of Special subframes or a guard period between UL and DL subframes. UL-DL configurations with switch-point periodicity equal to the frame period (e.g., 10 ms) or half of the frame period (e.g., 5 ms) may be supported. For example, TDD frames may include one or more Special frames, and the period between Special frames may determine the TDD DL-to-UL switch-point periodicity for the frame.

For LTE/LTE-A, seven different UL-DL configurations are defined that provide between 40% and 90% DL subframes as illustrated in Table 1.

TABLE 1

| UL-DL | Period | Subframe | | | | | | | | | |
|---|---|---|---|---|---|---|---|---|---|---|---|
| Configuration | (ms) | 0 | 1 | 2 | 3 | 4 | 5 | 6 | 7 | 8 | 9 |
| 0 | 5 | D | S | U | U | U | D | S | U | U | U |
| 1 | 5 | D | S | U | U | D | D | S | U | U | D |
| 2 | 5 | D | S | U | D | D | D | S | U | D | D |
| 3 | 10 | D | S | U | U | U | D | D | D | D | D |
| 4 | 10 | D | S | U | U | D | D | D | D | D | D |
| 5 | 10 | D | S | U | D | D | D | D | D | D | D |
| 6 | 5 | D | S | U | U | U | D | S | U | U | D |

Use of TDD offers flexible deployments without requiring paired spectrum resources. For TDD network deployments, interference may be caused between UL and DL communications (e.g., interference between UL and DL communication from different eNBs, interference between UL and DL communications from eNBs and UEs, etc.).

One interference mitigation technique is Cell Clustering Interference Mitigation (CCIM). In CCIM, cells are divided into cell clusters according to interference metrics (e.g., coupling loss, interference level, etc.) and TDD UL-DL configuration of cells within a cell cluster is synchronized so that eNB-to-eNB interference and UE-to-UE interference can be mitigated within the cell cluster (e.g., using cooperative scheduling, beamforming, etc.). Different cell clusters can use unsynchronized TDD UL-DL configurations, in order to adapt TDD UL-DL configurations of each cell cluster to the traffic conditions of the cluster.

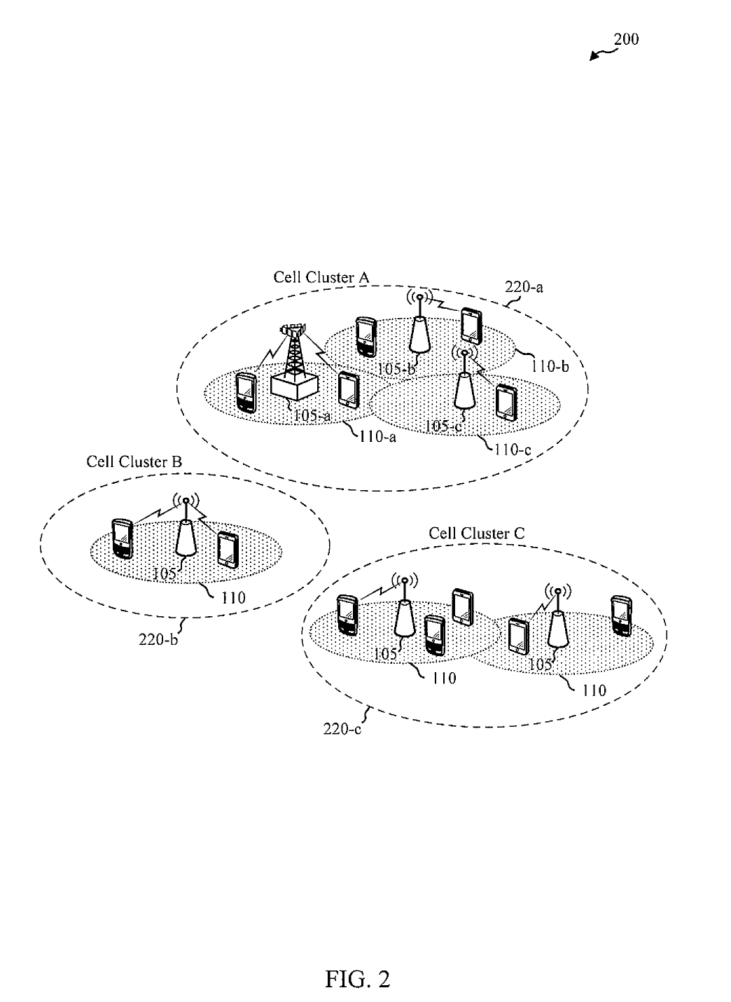

FIG. 2 illustrates a CCIM environment 200 with eNBs 105 grouped according to cell clusters 220. CCIM environment 200 may illustrate, for example, aspects of wireless communication system 100 illustrated in FIG. 1. Cell clusters 220 can include one or more eNBs 105 and eNBs 105 within a cell cluster 220 may be different types (e.g., macro eNB, pico eNB, femto eNB, and/or the like). As illustrated in the example of FIG. 2, CCIM environment 200 includes cell clusters 220-a, 220-b, and/or 220-c. Cell cluster 220-a may include eNB 105-a, eNB 105-b, and eNB 105-c. Cell clusters 220 may be statically or semi-statically defined and each eNB 105 in a cluster 220 may be aware of the other eNBs 105 of its cluster. Cell clusters 220-a, 220-b, and/or 220-c may deploy TDD carriers and TDD UL-DL configuration within each cell cluster 220 may be synchronized.

As discussed above, traffic adaptation for synchronized TDD UL-DL configuration within a cell cluster may be performed by coordination of TDD UL-DL reconfiguration between cells of the cluster. Semi-static (e.g., on the order of tens of frames) TDD UL-DL reconfiguration may be performed by exchange of control-plane messaging among eNBs (e.g., via S1 and/or X2 interfaces, etc.). While semi-static TDD UL-DL reconfiguration may provide adequate performance under some conditions, when traffic conditions within the cluster change rapidly, semi-static TDD UL-DL reconfiguration may result in sub-optimal allocation of UL-to-DL subframes for TDD carriers used in the cluster.

In embodiments, the different aspects of system 100 and/or CCIM environment 200, such as the eNBs 105, may be configured to provide dynamic intra-cluster coordination for TDD UL-DL reconfiguration. In embodiments, distributed TDD UL-DL reconfiguration techniques provide fully distributed, fair, and collision-free intra-cluster coordination of TDD UL-DL reconfiguration with adaptive reconfiguration on the order of a single frame period. In some embodiments, new physical layer signaling and/or techniques are defined for supporting dynamic intra-cluster coordination using distributed TDD UL-DL reconfiguration. Cell weighting techniques may be used so that distributed TDD UL-DL reconfiguration of the cell cluster 220 can be weighted towards cells of the cluster with higher load (e.g., DL and/or UL load).

In some embodiments, cells within a cell cluster 220 independently determine their preferred TDD UL-DL reconfiguration. One or more cells of the cluster may be eligible cells for a transmission opportunity to determine the TDD UL-DL reconfiguration for the cluster. Each of the eligible cells may determine the configuring cell. Determination of the configuring cell may be based on a pseudo-random function of cell identifiers of each cell of the cluster. Alternatively, the configuring cell may be determined based on at least one of a relative load, available capacity, fairness policy, cell priority, or tokenized function. The configuring cell may transmit the TDD UL-DL reconfiguration during the transmission opportunity. In some embodiments, the configuring cell may send the TDD UL-DL reconfiguration over backhaul interfaces to the other cells of the cluster.

In some embodiments, the configuring cell may transmit the TDD UL-DL reconfiguration using OTA physical layer signaling during the transmission opportunity. Other cells of the cluster may transmit OTA acknowledgments of the transmitted TDD UL-DL reconfiguration. In some embodiments, special subframes of the current TDD frame sequence that serve as a switching point between DL and UL transmissions are used for transmission of TDD UL-DL reconfiguration messages from the configuring cell and transmission of ACK messages from other cells of the cluster. The TDD UL-DL reconfiguration messages may be sent in a guard period of the special subframe. The TDD UL-DL reconfiguration message may be an orthogonal sequence based on a signature determined by its cell ID. A cyclic shift of the orthogonal sequence may be associated with a predetermined TDD UL-DL configuration. ACK messages may also be orthogonal sequences and may include the predetermined TDD UL-DL configuration.

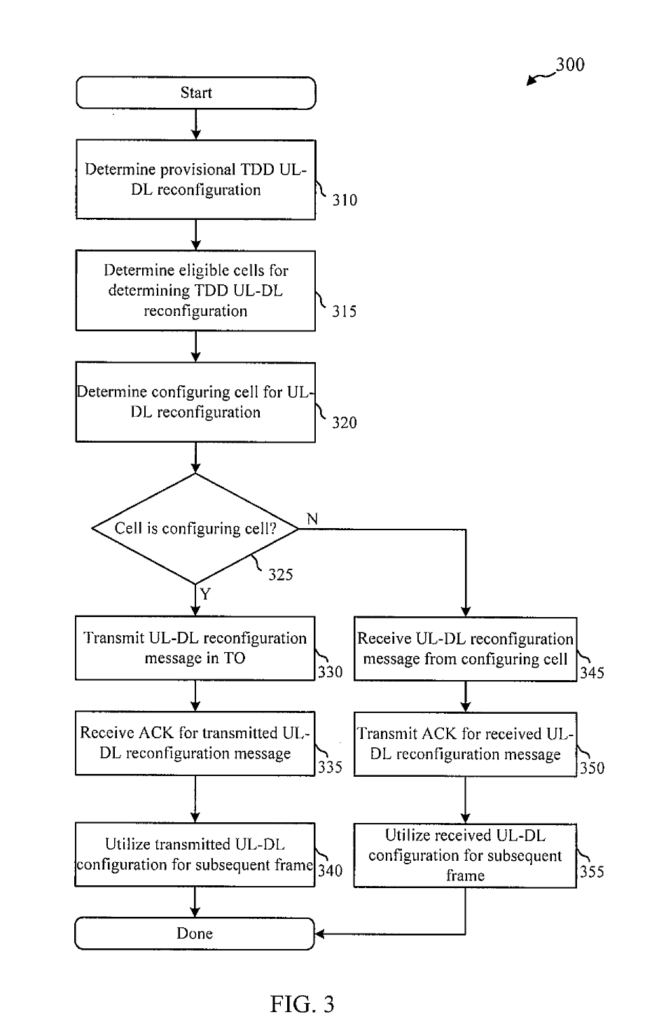

FIG. 3 illustrates a method 300 for intra-cluster coordination of TDD UL-DL configuration in accordance with various embodiments. Method 300 may be used in CCIM environment 200 for coordinating TDD UL-DL reconfiguration, effective for a subsequent radio frame (e.g., the next radio frame, etc.), with other eNBs of the cluster. Method 300 may be used, for example, by eNBs 105-a, 105-b, and/or 105-c of cell cluster 220-a.

Method 300 may begin at block 310 where the eNB 105 may determine a provisional TDD UL-DL configuration for the subsequent radio frame. The provisional TDD UL-DL configuration may be based on loading at the eNB (e.g., queue status at the eNB, Buffer Status Reports (BSR) of attached UEs, etc.) and may be the preferred TDD UL-DL configuration for the eNB 105 for the subsequent radio frame.

At block 315, the eNB 105 may determine the eligible cells of the cluster for determining TDD UL-DL reconfiguration at a transmission opportunity. For example, the eNB 105 may be aware of the other cells in its cluster and may determine that each cell, or a subset thereof, are eligible cells for determining the TDD UL-DL configuration for the subsequent radio frame. The eligible cells for a given frame and/or transmission opportunity may be determined based on the configuring cells for previous radio frames and/or other semi-statically configured parameters for the cell cluster as described in more detail below. Alternatively, the eligible cells may be based on at least one of a minimum load, remaining available capacity, fairness, priority, or tokenized function.

At block 320, the eNB 105 may determine the configuring cell for the subsequent radio frame. In embodiments, determination of the configuring cell is based on a pseudo-random function of the frame number and/or the cell IDs of the eligible cells determined at block 315. For example, eNB 105-a may determine that eNBs 105-a, 105-b, and 105-c are eligible cells for determining the TDD UL-DL configuration for the subsequent radio frame. To determine the configuring cell, eNB 105-a may compute a pseudo-random number for each eligible cell based on the frame number and the cell ID of the eligible cell. For example, the highest number generated by the pseudo-random function for the eligible cells may determine the configuring cell for TDD UL-DL reconfiguration. Alternatively, the configuring cell may be determined based on at least one of a relative load, available capacity, fairness policy, cell priority, or tokenized function. For example, a token may be passed from cell to cell of the cluster and possession of the token may determine the configuring cell.

If, at block 325, the eNB 105 determines that it is the configuring cell, the eNB 105 broadcasts its provisional UL-DL configuration for the subsequent radio frame to the other eNBs in the cluster at block 330. In some embodiments, the eNB 105 may send the provisional UL-DL configuration to the other cells in the cluster over backhaul interfaces (e.g., X2 interface, etc.) at block 330. For example, the provisional UL-DL configuration may be sent in an information element (IE) in radio network layer (e.g., X2 application protocol (X2-AP), etc.) messaging over the backhaul interfaces. The messaging may be synchronous or asynchronous and the subsequent radio frame may be identified in the messaging by frame number. In backhaul messaging implementations, the eNB 105 may receive radio network layer acknowledgement messaging of the broadcast provisional UL-DL configuration at block 335, or acknowledgement messaging at block 335 may be omitted and errors in messaging may be handled by the transport layer (e.g., stream control transmission protocol (SCTP), IP layer, etc.).

In some embodiments, the eNB 105 may transmit the provisional UL-DL configuration to the other cells in the cluster using OTA signaling at block 330. For example, a transmission opportunity for configuring the subsequent radio frame may be predetermined and the eNB 105 may transmit the provisional UL-DL configuration for the subsequent radio frame using the transmission opportunity. The provisional UL-DL configuration may be transmitted in a UL-DL reconfiguration message that may be an orthogonal sequence having a cycling shift associated with the provisional UL-DL configuration. Transmission of the provisional UL-DL configuration using OTA signaling may provide for synchronized reconfiguration across the cell cluster with reduced latency for reconfiguration. For example, UL-DL reconfiguration may be performed using OTA signaling for each 10 ms frame with latency on the order of a single 10 ms frame. Thus, OTA signaling may have advantages for some implementations over reconfiguration using backhaul messaging, which may not support deterministic timing for sending reconfiguration messages and thus may not be able to provide reconfiguration latency on the order of a single frame period.

In OTA signaling implementations, the eNB 105 may receive an acknowledgement (ACK) for the transmitted UL-DL configuration from one or more of the other eNBs in the cluster at block 335. In some embodiments, the ACK message from non-configuring eNBs includes the UL-DL configuration from the configuring cell so that other eNBs of the cluster that may not have received the transmitted UL-DL configuration from the configuring cell still receive the UL-DL configuration for the subsequent radio frame. At block 340, the eNB 105 utilizes the transmitted UL-DL configuration for the subsequent radio frame along with the other eNBs of the cluster.

If, at block 325, the eNB 105 determines that it is not the configuring cell, eNB 105 does not broadcast its TDD UL-DL configuration and instead receives a TDD UL-DL reconfiguration message from the configuring cell at block 345. As described above, the eNB 105 may receive the TDD UL-DL reconfiguration message at block 345 over backhaul interfaces (e.g., X2 interface, etc.) or OTA signaling.

At block 350, the eNB 105 may transmit an ACK message in response to receiving the UL-DL reconfiguration message. The eNB 105 may transmit, in the ACK message, the TDD UL-DL configuration received in the TDD UL-DL reconfiguration message. The eNB 105 may also transmit the cell ID of the configuring cell and/or its own cell ID in the ACK message. As described above, transmission of a radio network layer ACK message at block 350 may be omitted for implementations of TDD UL-DL reconfiguration using backhaul interfaces. The eNB 105 may utilize the received UL-DL configuration for the subsequent radio frame at block 355.

In some embodiments, new physical layer signaling procedures are used for OTA transmission of TDD UL-DL reconfiguration messages from the configuring cell of the cluster and acknowledgement of the reconfiguration messages by non-configuring cells. In some embodiments, configuring cells transmit TDD UL-DL configuration messages during switching periods between DL and UL subframes. Non-configuring cells may transmit acknowledgement messages during subsequent switching periods of the same or a subsequent radio frame. For example, a configuring cell may transmit the TDD UL-DL configuration message during a special subframe that serves as a switching point between DL and UL transmissions. Timing for acknowledgement messages and reconfiguration may depend on a current TDD UL-DL configuration. For example, some TDD UL-DL configurations (e.g., configurations 0, 1, 2, 6) may have a half-frame TDD duty-cycle while other configurations (e.g., configurations 3, 4, 5) may have a full frame TDD duty cycle. For half-frame duty cycle TDD UL-DL configurations, reconfiguration and acknowledgement messages may be sent in a single radio frame, while reconfiguration and acknowledgement messages may be sent over two radio frames for full frame duty-cycle TDD configurations.

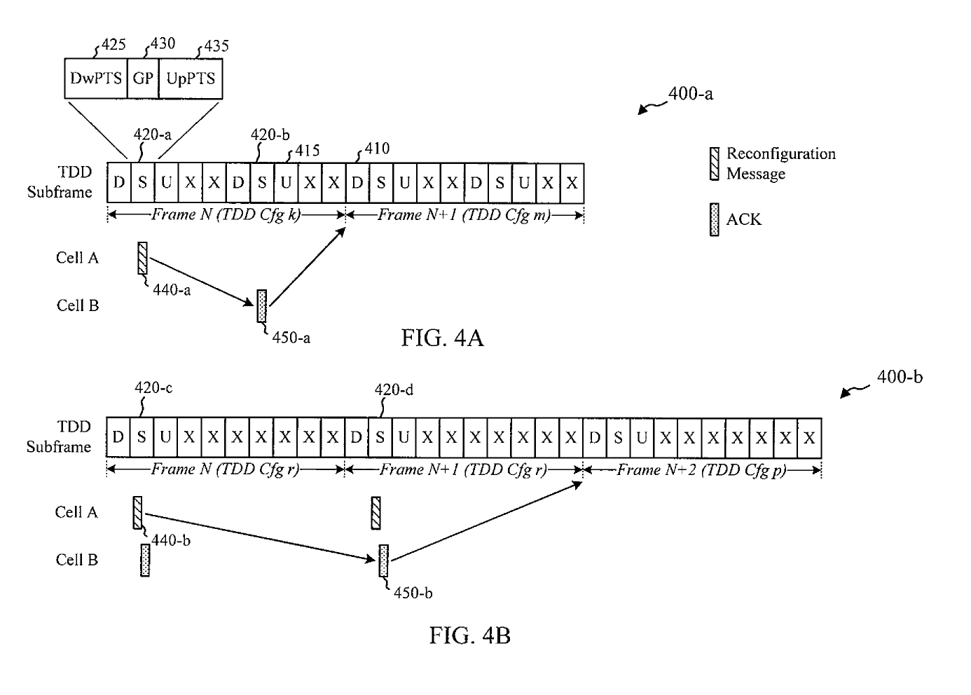

FIG. 4A and FIG. 4B show timing diagrams 400-a and 400-b illustrating TDD UL-DL reconfiguration using OTA physical layer signaling during special subframes in accordance with various embodiments. In timing diagrams 400-a and 400-b, downlink frames 410 are indicated by a “D,” uplink frames 415 are indicated by a “U,” special frames 420 are indicated by an “S,” and “X” frames may be either downlink or uplink frames based on the TDD UL-DL configuration. Special frames 420 may include three fields, Downlink Pilot Time Slot (DwPTS) 425, Guard Period (GP) 430, and Uplink Pilot Time Slot (UpPTS) 435.

Timing diagram 400-a illustrates a frame N and the subsequent frame N+1. During frame N, the TDD UL-DL configuration k may have a TDD period of 5 ms, or half of the frame period of 10 ms (e.g., TDD UL-DL configurations 0, 1, 2, 6, etc.). Cells A and B may be eligible cells of a cell cluster for determining the TDD UL-DL configuration for frame N+1 for the cell cluster. The first special subframe 420-a of frame N may be the transmission opportunity for TDD UL-DL configuration for frame N+1. Cell A may, based on the distributed TDD UL-DL reconfiguration techniques described above, be determined to be the configuring cell for frame N+1. Cell A may transmit TDD UL-DL reconfiguration message 440-a during the first special subframe 420-a of frame N. Cell A may transmit TDD UL-DL reconfiguration message 440-a using a subset of frequency resources of the TDD carrier (e.g., PRACH, etc.).

TDD UL-DL reconfiguration message 440-a may include the cell ID of cell A and the TDD UL-DL configuration (configuration m in this example) for frame N+1. The TDD UL-DL configuration for frame N+1 may be used for subsequent radio frames until a further reconfiguration message is transmitted by a configuring cell. Other cells of the cluster (e.g., other eligible cells and/or non-eligible cells) may transmit an ACK message during the second special subframe 420-b of frame N. As illustrated in timing diagram 400-a, cell B transmits ACK message 450-a during special subframe 420-b. Transmission of TDD UL-DL reconfiguration messages 440 may be contention based while transmission of ACK messages 450 may be non-contention based.

Timing diagram 400-b illustrates frames N, N+1, and N+2, where frame N is configured according to TDD UL-DL configuration r (e.g., TDD UL-DL configurations 3, 4, 5, etc.) with a TDD period that is the same as the frame period (e.g., 10 ms). In timing diagram 400-b, cells A and B may be eligible cells of a cell cluster for determining the TDD UL-DL configuration for frame N+2 for the cell cluster. Cell A may, based on the distributed TDD UL-DL reconfiguration techniques described above, be determined to be the configuring cell for frame N+2 and may transmit TDD UL-DL reconfiguration message 440-b during the special subframe 420-c of frame N. TDD UL-DL reconfiguration message 440-b may configure frame N+2 according to TDD UL-DL configuration p. Other cells of the cluster (e.g., other eligible cells and/or non-eligible cells) may transmit an ACK message during the special subframe 420-d of frame N+1. As illustrated in timing diagram 400-b, cell B transmits ACK message 450-b during special subframe 420-d and the TDD UL-DL configuration for the cluster is reconfigured according to configuration p in frame N+2 (and subsequent frames in some examples).

As illustrated in timing diagram 400-b, TDD UL-DL reconfiguration may have a latency from the TDD UL-DL reconfiguration message 440 to utilization of the new configuration of two frames (e.g., TDD UL-DL reconfiguration message transmitted in frame N with reconfiguration effective in frame N+2). However, in some examples TDD UL-DL reconfiguration messages may be transmitted during each frame. Thus, reconfiguration may occur dynamically on a frame-by-frame basis even where reconfiguration latency is more than one frame period.

ACK messages 450 may include the cell ID of the configuring cell and/or the cell transmitting the ACK message 450, and may include the configuration from the TDD UL-DL reconfiguration message, in some embodiments. Transmission of the TDD UL-DL configuration in the ACK message 450 may inform cells of the cluster that did not receive the TDD UL-DL reconfiguration message 440 of the TDD UL-DL configuration for the configured frame.

While timing diagrams 400-a and 400-b illustrate dynamic reconfiguration between TDD UL-DL configurations having the same TDD period, it should be appreciated that similar techniques may be used for dynamic reconfiguration between TDD UL-DL configurations having different TDD periods. For example, reconfiguration between a TDD UL-DL configuration having a half-frame TDD period and a TDD UL-DL configuration having a full-frame TDD period may be performed using similar techniques to those illustrated in timing diagram 400-a, and reconfiguration between a TDD UL-DL configuration having a full-frame TDD period and a TDD UL-DL configuration having a half-frame TDD period may be performed using similar techniques to those illustrated in timing diagram 400-b (e.g., suppressing additional reconfiguration messages in frame N+1).

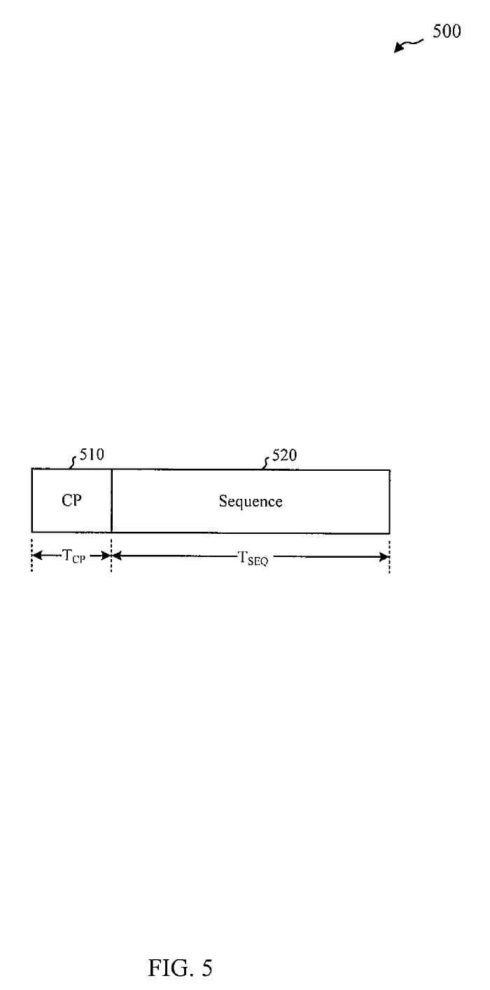

In some embodiments, TDD UL-DL reconfiguration messages may be transmitted using orthogonal sequences carrying the cell ID of the configuring cell and the TDD UL-DL configuration. FIG. 5 illustrates an orthogonal sequence 500 for transmitting TDD UL-DL configurations in accordance with various embodiments. Orthogonal sequence 500 may include a cyclic prefix part 510 of length T_{CP} and a sequence part 520 of length T_{SEQ}. Orthogonal sequence 500 may be an example of a Zadoff-Chu sequence where cyclically shifted versions of the orthogonal sequence have low (e.g., zero or almost zero) auto-correlation with one another. In some examples, orthogonal sequence 500 is a modified random access preamble sequence with T_{CP}=624·Tₛ and T_{SEQ}=4092·Tₛ. The sequence 520 may be based on the cell ID of the configuring cell and a cyclic shift of each preamble sequence may be associated with a predetermined TDD UL-DL configuration. Orthogonal sequence 500 may be used for transmitting TDD UL-DL reconfiguration messages and/or ACK messages within special subframes as described above.

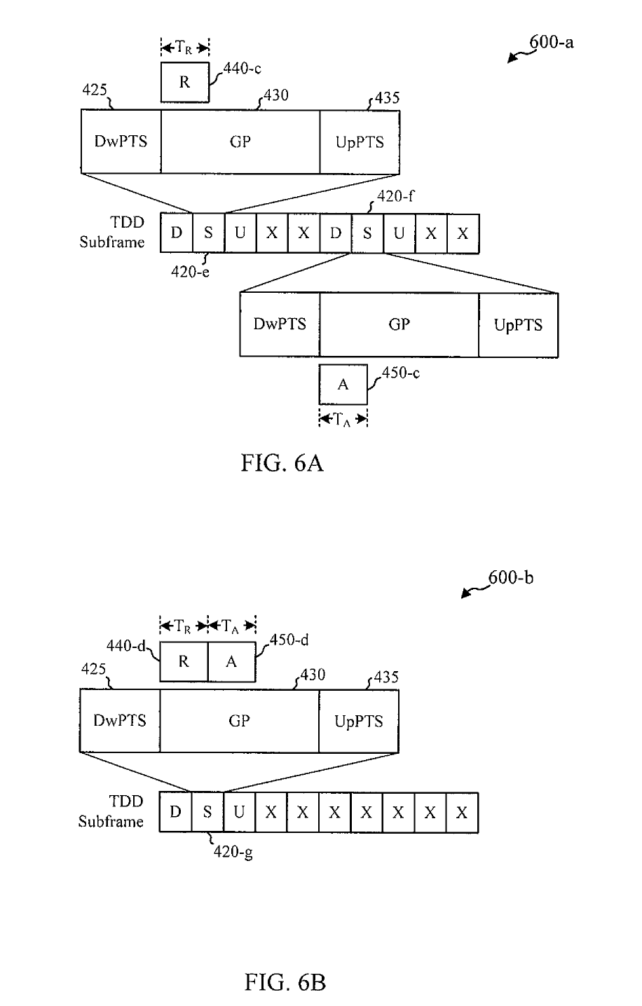

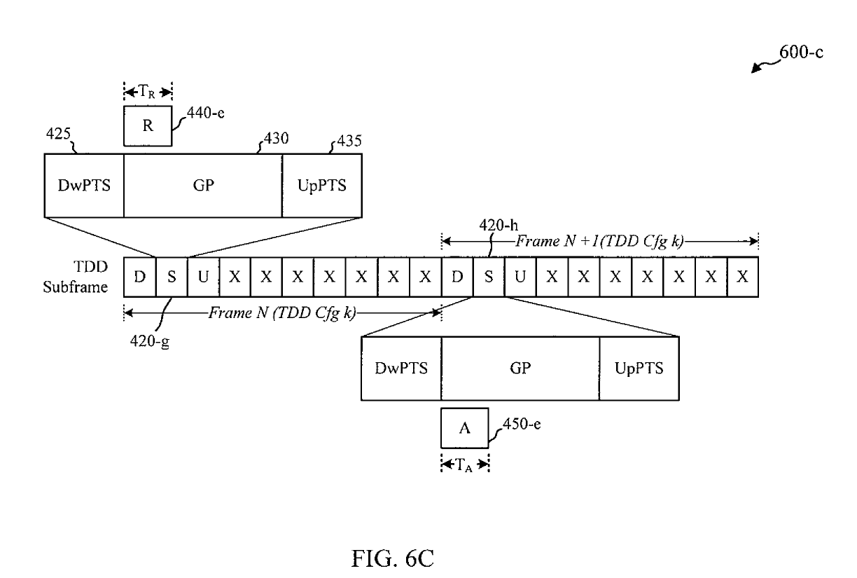

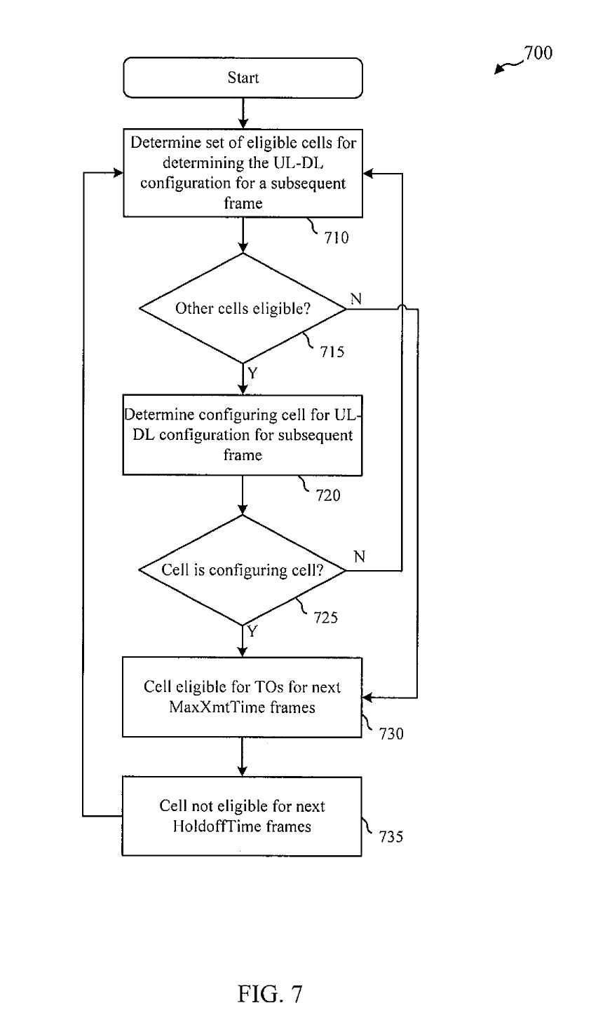

FIG. 6A is a timing diagram 600-a illustrating timing of preamble sequences transmitted for dynamic TDD UL-DL reconfiguration in a TDD frame having a half-period TDD switching period in accordance with various embodiments. As illustrated in timing diagram 600-a, a TDD UL-DL reconfiguration message 440-c may be sent as a preamble sequence within a period T_{R} of the guard period 430 of special frame 420-e. ACK message 450-c may be sent as a preamble sequence within a period T_{A} of the guard period 430 of special frame 420-f. Periods T_{R} and/or T_{A} may have a length greater than T_{CP}+T_{SEQ} to account for possible propagation delay. For example, in some embodiments T_{A}=T_{R}=5120·Tₛ.

Where the TDD switch period is equal to the radio frame period, each radio frame only has a single special subframe. In some instances, TDD UL-DL reconfiguration messages 440 and ACK messages 450 may be transmitted within the same special subframe. For example, a configuring cell may transmit, during a frame N, a TDD UL-DL reconfiguration message 440 for frame N+2, while the same or a different cell may transmit an ACK message 450 for a previously received TDD UL-DL reconfiguration message 440 associated with frame N+1. FIG. 6B is a timing diagram 600-b illustrating timing of preamble sequences transmitted for dynamic TDD UL-DL reconfiguration in a TDD frame where the TDD switching period is equal to the radio frame period in accordance with various embodiments. As illustrated in timing diagram 600-b, periods T_{R} and T_{A} may be used for transmission of the TDD UL-DL reconfiguration message 440-d and ACK message 450-d within special subframe 420-g, respectively.

In other instances, TDD UL-DL reconfiguration messages may not be transmitted during certain radio frames even where the TDD switch period is equal to the radio frame period. For example, for particular radio frames, there may be no eligible cells for TDD UL-DL reconfiguration, or reconfiguration transmitted during a frame N may change the TDD switch periodicity to half-period TDD switching. In other examples, the guard period may not be long enough for transmission of a TDD UL-DL reconfiguration message and ACK message within one guard period. In these instances, TDD UL-DL reconfiguration messages may be transmitted during a special subframe of one frame while ACK messages may be transmitted during a special subframe of the following frame. FIG. 6C is a timing diagram 600-c illustrating alternative timing of preamble sequences transmitted for dynamic TDD UL-DL reconfiguration in a TDD frame where the TDD switching period is equal to the radio frame period in accordance with various embodiments. Timing diagram 600-c illustrates transmission of the TDD UL-DL reconfiguration message 440-e during subframe 420-g of the frame N and transmission of the ACK message 450-e during subframe 420-h of frame N+1.

The above techniques provide dynamic distributed TDD UL-DL reconfiguration on the order of the frame time and fair TDD UL-DL allocations across cells within a cluster. In some embodiments, cell weighting may be used so that TDD UL-DL configuration of the cell cluster can be weighted towards cells with higher load (e.g., DL and/or UL load). Weighted dynamic distributed TDD UL-DL reconfiguration may include parameters that determine the eligible interval and/or a holdoff time between eligible intervals for cells within a cluster.

In embodiments, a cell-specific parameter MaxXmtTime determines the eligible interval for each cell of the cluster and may be dependent on cell loading (e.g., DL and/or UL loading). Each cell can exchange MaxXmtTime values semi-statically via backhaul. In embodiments, a HoldoffTime parameter may determine a minimum interval of radio frames between eligible intervals. The HoldoffTime parameter may be cluster-specific and may be based on the size of the cluster.

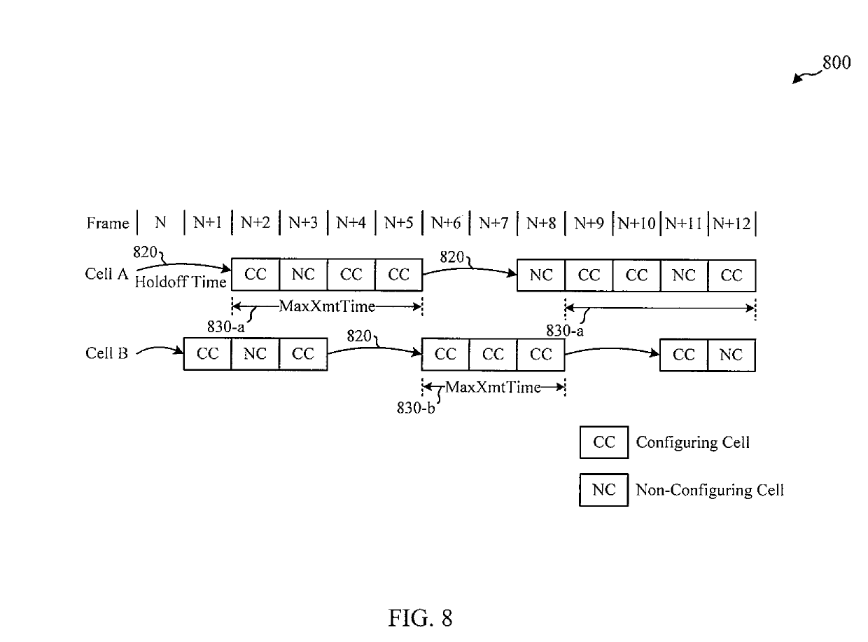

FIG. 7 illustrates a method 700 for weighted dynamic distributed TDD UL-DL reconfiguration in accordance with various embodiments. Method 700 may be used in CCIM environment 200 for coordinating TDD UL-DL configuration for a subsequent radio frame (e.g., the next radio frame, etc.) with other eNBs of the cluster. Method 700 may be used, for example, by eNBs 105-a, 105-b, and/or 105-c of cell cluster 220-a. In addition, method 700 may be used in combination with the techniques for distributed TDD UL-DL reconfiguration described above. For example, method 700 may be used in combination with method 300 illustrated in FIG. 3.

Method 700 may start at block 710 where a cell may determine the set of eligible cells for determining the UL-DL configuration for a subsequent frame. Determining the set of eligible cells may be based on the MaxXmtTime and HoldoffTime parameters. For example, the cell may initially assume that all cells are eligible cells. The MaxXmtTime parameters for each cell in the cluster may be distributed to all cells of the cluster. The cell may track the eligible cells for determining the UL-DL configuration based in the MaxXmtTime and HoldoffTime parameters for each cell as well as the sequence of configuring cells for prior frames. If, at block 715, the cell determines that it is eligible and there are other eligible cells for determining the UL-DL configuration for the subsequent frame, method 700 may proceed to block 720. If, at block 715, the cell determines that it is eligible and there are no other eligible cells, it may proceed to block 730 as it will be the configuring cell for the subsequent frame by default.

At block 720, the cell determines the configuring cell from the set of eligible cells. If the cell is the configuring cell, the cell “competes” to be the configuring cell for the next MaxXmtTime number of frames. After competing to be the configuring cell for MaxXmtTime frames, the cell may wait at block 735 for the next HoldoffTime number of frames without being eligible to be the configuring cell. After waiting HoldoffTime frames at block 735, the method 700 may return to block 710. If, at block 725, the cell determines that it is not the configuring cell for the subsequent frame, it may maintain its eligibility for an additional frame by returning to block 710.

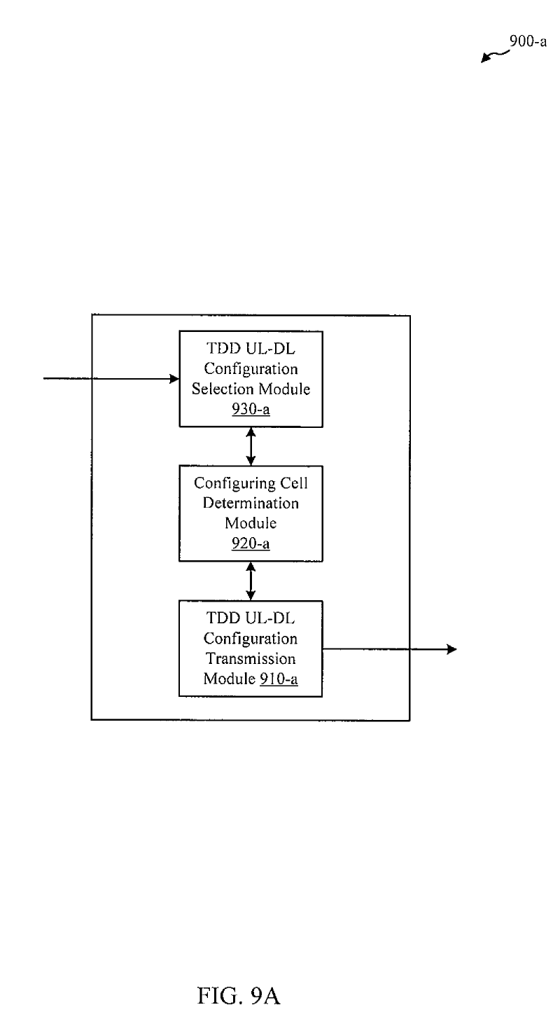

FIG. 8 is a timing diagram 800 that illustrates an example sequence of weighted dynamic distributed TDD UL-DL reconfiguration in accordance with various embodiments. In timing diagram 800, two cells (cells A and B) may be in a cell cluster 220. Timing diagram 800 may illustrate, for example, implementation of method 700 in a two-cell cluster 220. In timing diagram 800, HoldoffTime may be equal to two frames. The MaxXmtTime parameter 830-a for cell A may be set, during the time period illustrated by timing diagram 800, to four frames while the MaxXmtTime parameter 830-b for cell B may be set to three frames.

At a frame N, neither cell may be eligible for configuring the subsequent frame (e.g., frame N+1, frame N+2). At frame N+1, cell B may be eligible for being the configuring cell while cell A is not eligible. Because cell B is the only eligible cell, cell B will be the configuring cell for the transmission opportunity in frame N+1. At frame N+2, both cells A and B may be eligible cells. Each cell may determine the configuring cell for frame N+2 using a pseudo-random function that is based on the frame number and cell IDs of cells A and B. Based on the pseudo-random function, cell A may be determined to be the configuring cell for the transmission opportunity in frame N+2. Cell A may then continue to be eligible for MaxXmtTime 830-a frames before waiting (e.g., ineligible) for HoldoffTime 820 frames.

At frame N+8, cells A and B may be eligible for the transmission opportunity in frame N+8 (e.g., for TDD UL-DL reconfiguration for frame N+9, etc.). Cell B may be determined to be the configuring cell for the transmission opportunity in frame N+8. Cell A may then continue to be eligible for frame N+9 and/or additional frames until Cell A is determined to be the configuring cell. Cell A may then remain eligible for MaxXmtTime 830-a frames.

As described above, communication of messaging over backhaul interfaces may be used, in addition or alternatively to OTA signaling for sending TDD UL-DL configuration information. For these implementations, the configuring cell may be determined for each frame using the pseudo-random function based on the frame number and cell IDs of eligible cells for configuring the frames. For example, cells A and B may be eligible cells for configuring the TDD UL-DL configuration for frame N+2. Cell A may be determined as the configuring cell for frame N+2 and may send messages over backhaul interfaces to the other cells of the cluster indicating the selected TDD UL-DL configuration for frame N+2.

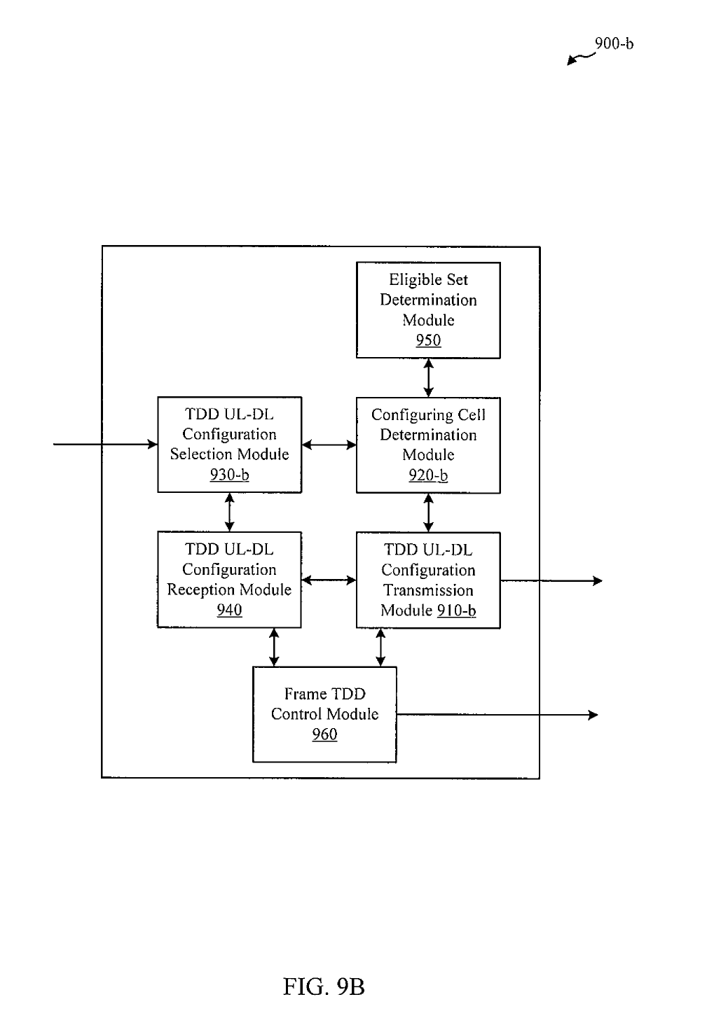

FIG. 9A illustrates a device 900-a for supporting dynamic distributed TDD UL-DL reconfiguration within cell clusters in accordance with various embodiments. Device 900-a may illustrate, for example, aspects of eNBs 105 of FIG. 1 and/or FIG. 2. Device 900-a may also be a processor. Device 900-a may include TDD UL-DL configuration transmission module 910-a, configuring cell determination module 920-a, and TDD UL-DL configuration selection module 930-a. Each of these components may be in communication with each other.

TDD UL-DL configuration selection module 930-a may select a provisional TDD UL-DL configuration for a subsequent frame. The provisional TDD UL-DL configuration may be selected based on loading (e.g., DL and/or UL loading) conditions at the cell. Configuring cell determination module 920-a may determine a configuring cell from a set of eligible cells for a transmission opportunity associated with UL-DL configuration for the subsequent TDD frame. Configuring cell determination module 920-a may determine the configuring cell using a pseudo-random function based on the frame number and cell identifiers of the set of eligible cells.

If the cell is the configuring cell for the subsequent TDD frame, TDD UL-DL configuration transmission module 910-a may transmit the provisional TDD UL-DL configuration to the other cells of the cluster. In some embodiments, TDD UL-DL configuration transmission module 910-a may send the provisional TDD UL-DL configuration to the other cells using backhaul interfaces. In some embodiments, TDD UL-DL configuration transmission module 910-a may transmit the provisional TDD UL-DL configuration using OTA signaling in the transmission opportunity associated with UL-DL configuration for the subsequent TDD frame. For example, TDD UL-DL configuration transmission module 910-a may transmit an orthogonal sequence generated from a cell identifier of the cell during a special subframe of the current TDD frame.

FIG. 9B illustrates a device 900-b for supporting dynamic distributed TDD UL-DL reconfiguration within cell clusters in accordance with various embodiments. Device 900-b may illustrate, for example, aspects of eNBs 105 of FIG. 1 and/or FIG. 2. Device 900-b may also be a processor. Device 900-b may include TDD UL-DL configuration transmission module 910-b, configuring cell determination module 920-b, TDD UL-DL configuration selection module 930-b, TDD UL-DL configuration reception module 940, eligible set determination module 950, and/or frame TDD control module 960. Each of these components may be in communication with each other. Various components for device 900-b may be configured to implement aspects discussed above with respect to device 900-a of FIG. 9A. For example, the TDD UL-DL configuration transmission module 910-b, configuring cell determination module 920-b, and TDD UL-DL configuration selection module 930-b may perform the functions described above with reference to TDD UL-DL configuration transmission module 910-a, configuring cell determination module 920-a, and TDD UL-DL configuration selection module 930-a.

When the cell of device 900-b is determined by configuring cell determination module 920-b to be the configuring cell, frame TDD control module 960 may utilize, for the subsequent frame, the configuration selected by TDD UL-DL configuration selection module 930 (and transmitted to the other cells by TDD UL-DL configuration transmission module 910-b). In frames where the cell of device 900-b is not the configuring cell, TDD UL-DL configuration reception module 940 may receive a TDD UL-DL configuration from the configuring cell. Frame TDD control module 960 may utilize the received TDD UL-DL configuration for the subsequent frame.

Eligible set determination module 950 may track the cells of the cluster that are eligible for configuring each radio frame. For example, eligible set determination module 950 may determine the eligible set for each frame based in part on the MaxXmtTime parameters for each cell of the cluster and the HoldoffTime parameter for the cluster.

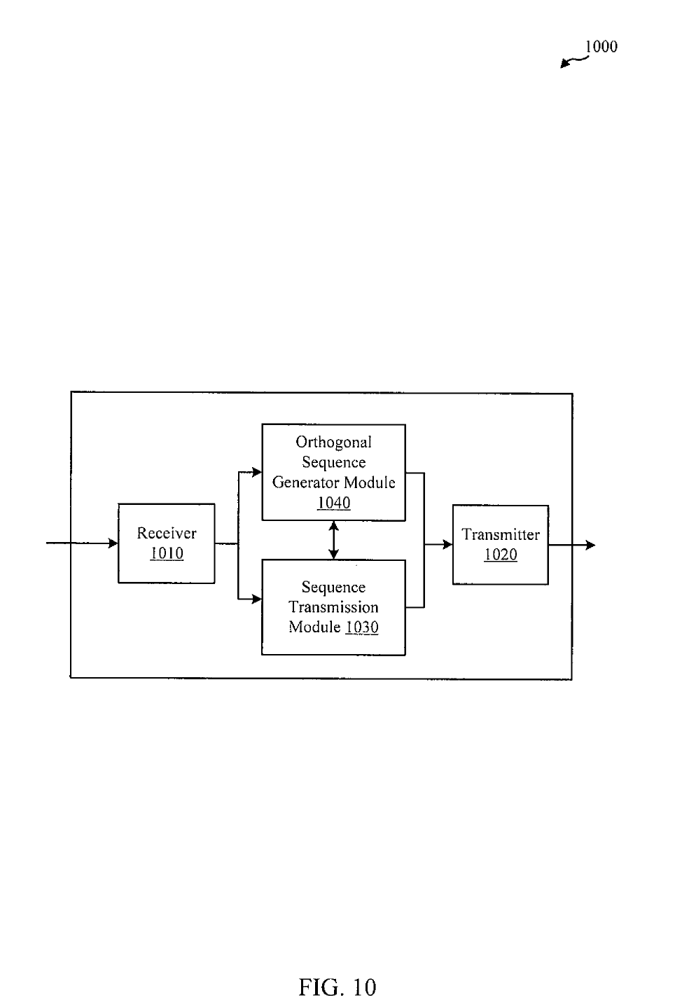

FIG. 10 illustrates a device 1000 for communicating TDD UL-DL reconfiguration within cell clusters in accordance with various embodiments. Device 1000 may illustrate, for example, aspects of eNBs 105 of FIG. 1 and/or FIG. 2. Device 1000 may also be a processor. Device 10000 may include receiver 1010, transmitter 1020, orthogonal sequence generator module 1040, and sequence transmission module 1030. Each of these components may be in communication with each other.

Orthogonal sequence generator module 1040 may an orthogonal sequence encoded with a cell identifier of the cell and an UL-DL configuration for a subsequent frame of a TDD carrier for transmission to other cells of a cluster. The orthogonal sequence may be, for example, a modified random access preamble where a cyclic shift of the orthogonal sequence is associated with the UL-DL configuration. The sequence transmission module 1030 may transmit (e.g., via transmitter 1020), the orthogonal sequence to at least one other cell of the cluster. The sequence transmission module 1030 may transmit the orthogonal sequence during a special subframe of a frame of a TDD carrier. The receiver 1010 may receive an acknowledgement of reception of the orthogonal sequence by the at least one cell during a special subframe of the same frame or of a different frame.

The components of devices 900-a, 900-b and/or 1000 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

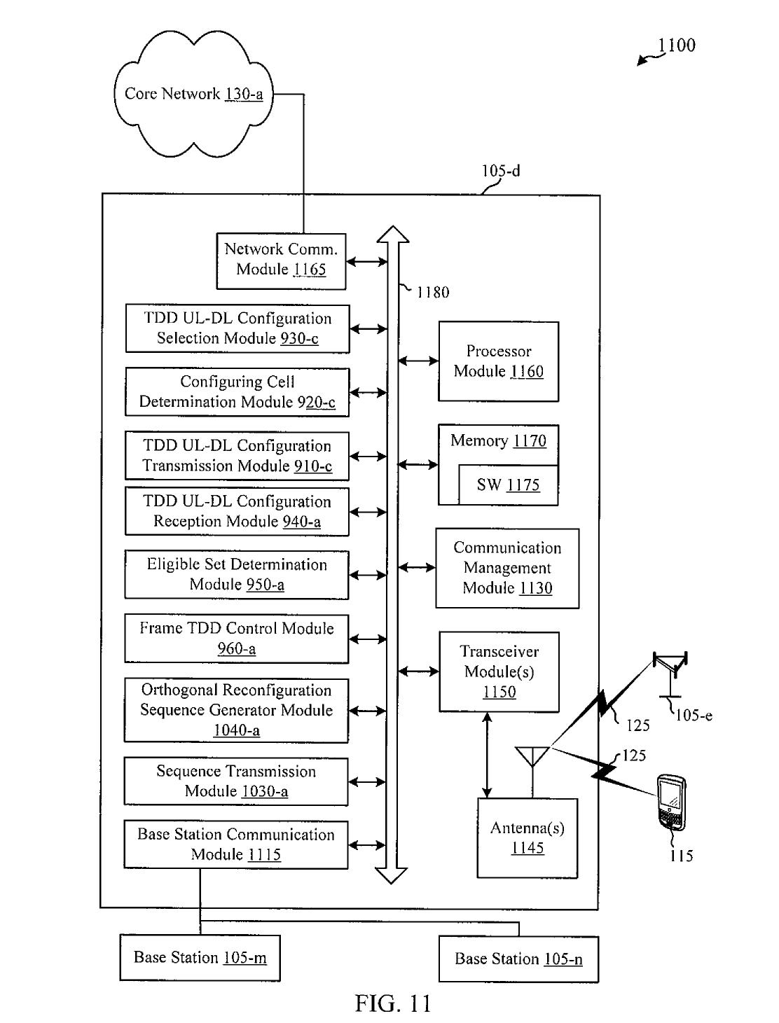

FIG. 11 shows a block diagram of a communications system 1100 that may be configured for supporting dynamic distributed TDD UL-DL reconfiguration within cell clusters in accordance with various embodiments. This system 1100 may be an example of aspects of the system 100 depicted in FIG. 1 and/or CCIM environment 200 of FIG. 2. The system 1100 includes a base station 105-d configured for communication with UE 115 and/or eNB 105-e over wireless communication links 125. Base station 105-d may be, for example, an eNB 105 as illustrated in systems 100 and/or 200.

In some cases, the base station 105-d may have one or more wired backhaul links. Base station 105-d may be, for example, a macro eNB 105 having a wired backhaul link (e.g., S1 interface, etc.) to the core network 130-a. Base station 105-d may also communicate with other base stations 105, such as base station 105-m and base station 105-n via inter-base station communication links (e.g., X2 interface, etc.). Each of the base stations 105 may communicate with UEs 115 using different wireless communications technologies, such as different Radio Access Technologies. In some cases, base station 105-d may communicate with other base stations such as 105-m and/or 105-n utilizing base station communication module 1115. In some embodiments, base station communication module 1115 may provide an X2 interface within an LTE/LTE-A wireless communication network technology to provide communication between some of the base stations 105. In some embodiments, base station 105-d may communicate with other base stations through core network 130-a.

The components for base station 105-d may be configured to implement aspects discussed above with respect to devices 900-a, 900-b, and/or 1000 of FIG. 9A, FIG. 9B, and/or FIG. 10 and may not be repeated here for the sake of brevity. For example, the TDD UL-DL configuration transmission module 910-c may perform the functions described above of the TDD UL-DL configuration transmission modules 910, configuring cell determination module 920-c may perform the functions described above of the configuring cell determination modules 920, TDD UL-DL configuration selection module 930-c may perform the functions described above of the TDD UL-DL configuration selection modules 930, TDD UL-DL configuration reception module 940-a may perform the functions described above of the UL-DL configuration reception module 940, eligible set determination module 950-a may perform the functions described above of the eligible set determination module 950, frame TDD control module 960-a may perform the functions described above of the frame TDD control module 960, orthogonal sequence generator module 1040-a may perform the functions described above of the orthogonal sequence generator module 1040, and sequence transmission module 1030-a may perform the functions described above of the sequence transmission module 1030. By way of example, these modules may be components of the base station 105-d in communication with some or all of the other components of the base station 105-d via bus system 1180. Alternatively, functionality of these modules may be implemented as a component of the transceiver module 1150, as a computer program product, and/or as one or more controller elements of the processor module 1160.

The base station 105-d may include antennas 1145, transceiver modules 1150, memory 1170, and a processor module 1160, which each may be in communication, directly or indirectly, with each other (e.g., over bus system 1180). The transceiver modules 1150 may be configured to communicate bi-directionally, via the antennas 1145, with the user equipment 115, which may be a multi-mode user equipment. The transceiver module 1150 (and/or other components of the base station 105-d) may also be configured to communicate bi-directionally, via the antennas 1145, with one or more other base stations 105-e. The transceiver module 1150 may include a modem configured to modulate the packets and provide the modulated packets to the antennas 1145 for transmission, and to demodulate packets received from the antennas 1145. The base station 105-d may include multiple transceiver modules 1150, each with one or more associated antennas 1145.

The memory 1170 may include random access memory (RAM) and read-only memory (ROM). The memory 1170 may also store computer-readable, computer-executable software code 1175 containing instructions that are configured to, when executed, cause the processor module 1160 to perform various functions described herein (e.g., call processing, database management, message routing, etc.). Alternatively, the software 1175 may not be directly executable by the processor module 1160 but be configured to cause the computer, e.g., when compiled and executed, to perform functions described herein.

The processor module 1160 may include an intelligent hardware device, e.g., a central processing unit (CPU) such as those made by Intel® Corporation or AMD®, a microcontroller, an application-specific integrated circuit (ASIC), etc. The processor module 1160 may include various special purpose processors such as encoders, queue processing modules, base band processors, radio head controllers, digital signal processors (DSPs), and the like.

According to the architecture of FIG. 11, the base station 105-d may further include a communications management module 1130. The communications management module 1130 may manage communications with other base stations 105. The communications management module may include a controller and/or scheduler for controlling communications with UEs 115 in cooperation with other base stations 105. For example, the communications management module 1130 may perform scheduling for transmissions to UEs 115 and/or various interference mitigation techniques such as beamforming and/or joint transmission.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software/firmware, or combinations thereof. If implemented in software/firmware, the functions may be stored on or transmitted over as one or more instructions or code on a computer-readable medium. Other examples and implementations are within the scope and spirit of the disclosure and appended claims. For example, due to the nature of software/firmware, functions described above can be implemented using software/firmware executed by, e.g., a processor, hardware, hardwiring, or combinations thereof. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general-purpose or special-purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software/firmware is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

1. A method for coordinating time division duplex (TDD) uplink-downlink (UL-DL) configuration for a cell cluster of a wireless communications network, comprising:
determining, at a cell in the cell cluster, a configuring cell from a set of eligible cells for UL-DL configuration for a subsequent TDD frame, the set of eligible cells including the cell and at least one other cell in the cell cluster;
selecting, if the cell is the configuring cell, a first TDD UL-DL configuration for the subsequent TDD frame; and
sending, if the cell is the configuring cell, the first TDD UL-DL configuration for the subsequent TDD frame to cells of the cell cluster.

2. The method of claim 1, wherein determining the configuring cell comprises:
determining the configuring cell based on at least one of a pseudo-random, relative load, available capacity, fairness, priority, or tokenized function based at least in part on cell identifiers of the set of eligible cells.

3. The method of claim 1, wherein sending the first TDD UL-DL configuration comprises sending a message comprising the first TDD UL-DL configuration to the cells of the cell cluster over a backhaul interface.

4. The method of claim 1, wherein sending the first TDD UL-DL configuration comprises transmitting an indicator of the first TDD UL-DL configuration in a transmission opportunity of a TDD frame preceding the subsequent TDD frame.

5. The method of claim 4, wherein the transmission opportunity comprises a gap period between downlink and uplink subframes of the preceding TDD frame.

6. The method of claim 1, further comprising:
receiving, if the cell is not the configuring cell, a second TDD UL-DL configuration for the subsequent TDD frame from the configuring cell; and
utilizing the second UL-DL configuration for the subsequent TDD frame.

7. The method of claim 6, further comprising:
transmitting an acknowledgement of the received second TDD UL-DL configuration.

8. The method of claim 7, wherein the second TDD UL-DL configuration is received within a gap period between downlink and uplink subframes of a TDD frame and the acknowledgement is transmitted within a subsequent gap period within the TDD frame.

9. The method of claim 7, wherein the acknowledgement comprises the received TDD UL-DL configuration.

10. The method of claim 1, further comprising:
determining the set of eligible cells based at least in part on eligible intervals and holdoff periods for cells of the cell cluster.

11. The method of claim 10, further comprising:
determining that the cell is in the set of eligible cells for a number of additional TDD frames of an eligible interval based at least in part on determining that the cell is the configuring cell for a TDD frame preceding the additional TDD frames.

12. The method of claim 10, wherein eligible intervals for cells of the cell cluster are based at least in part on loading metrics of the cells.

13. The method of claim 10, wherein eligible intervals for the configuring cell of the cell cluster are separated by at least one holdoff period.

14. The method of claim 1, wherein the transmitting comprises:
transmitting an orthogonal sequence based on a cell identifier of the cell.

15. The method of claim 14, wherein a cyclic shift of the orthogonal sequence is associated with one TDD UL-DL configuration of a set of predefined TDD UL-DL configurations for the wireless communications network.

16. A method for communicating time division duplex (TDD) uplink-downlink (UL-DL) configurations between cells of a cell cluster of a wireless communications network, comprising:
generating, at a cell of the cell cluster, an orthogonal sequence encoded with a cell identifier of the cell and a TDD UL-DL configuration for a subsequent frame of a TDD carrier; and
transmitting, to at least one cell of the cell cluster, the orthogonal sequence during a first special subframe of a first frame of the TDD carrier.

17. The method of claim 16, further comprising:
receiving, from the at least one cell, an acknowledgement of reception of the orthogonal sequence by the at least one cell, wherein the acknowledgement is received during a second special subframe of the first frame.

18. The method of claim 17, wherein the received acknowledgement comprises an orthogonal acknowledgement sequence, the orthogonal acknowledgement sequence encoded with the TDD UL-DL configuration.

19. The method of claim 16, further comprising:
receiving, from the at least one cell, an acknowledgement of reception of the orthogonal sequence by the at least one cell during a second special subframe of a second frame subsequent to the first frame.

20. The method of claim 16, wherein transmitting the orthogonal sequence comprises:
transmitting the orthogonal sequence within a gap period between downlink and uplink transmission portions of the first special subframe.

21. The method of claim 16, wherein a cyclic shift of the orthogonal sequence is associated with the TDD UL-DL configuration.

22. An apparatus for coordinating time division duplex (TDD) uplink-downlink (UL-DL) configuration for a cell cluster of a wireless communications network, comprising:
means for determining, at a cell of the cell cluster, a configuring cell from a set of eligible cells for UL-DL configuration for a subsequent TDD frame, the set of eligible cells including the cell and at least one other cell in the cell cluster;
means for selecting, if the cell is the configuring cell, a first TDD UL-DL configuration for the subsequent TDD frame; and
means for sending, if the cell is the configuring cell, the first TDD UL-DL configuration for the subsequent TDD frame to cells of the cell cluster.

23. The apparatus of claim 22, wherein the means for determining the configuring cell determines the configuring cell based on at least one of a pseudo-random, relative load, available capacity, fairness, priority, or tokenized function based at least in part on cell identifiers of the set of eligible cells.

24. The apparatus of claim 22, wherein the means for sending the first TDD UL-DL configuration sends a message comprising the first TDD UL-DL configuration to the cells of the cell cluster over a backhaul interface.

25. The apparatus of claim 22, wherein the means for sending the first TDD UL-DL configuration transmits an indicator of the first TDD UL-DL configuration in a transmission opportunity of a TDD frame preceding the subsequent TDD frame.

26. The apparatus of claim 22, further comprising:
means for receiving, if the cell is not the configuring cell, a TDD UL-DL configuration for the subsequent TDD frame from the configuring cell; and
means for utilizing the TDD UL-DL configuration for the subsequent TDD frame.

27. An apparatus for communicating time division duplex (TDD) uplink-downlink (UL-DL) configurations between cells of a cell cluster of a wireless communications network, comprising:
means for generating, at a cell of the cell cluster, an orthogonal sequence encoded with a cell identifier of the cell and a TDD UL-DL configuration for a subsequent frame of a TDD carrier; and
means for transmitting, to at least one cell of the cell cluster, the orthogonal sequence during a first special subframe of a first frame of the TDD carrier.

28. The apparatus of claim 27, further comprising:
means for receiving, from the at least one cell, an acknowledgement of reception of the orthogonal sequence by the at least one cell during a second special subframe of the first frame.

29. The apparatus of claim 27, further comprising:
means for receiving, from the at least one cell, an acknowledgement of reception of the orthogonal sequence by the at least one cell during a second special subframe of a second frame subsequent to the first frame.

30. The apparatus of claim 27, wherein a cyclic shift of the orthogonal sequence is associated with the TDD UL-DL configuration.
